(19) United States
(12) Patent Application Publication
(10) Pub. No.: US 2002/0023110 A1
(43) Pub. Date: Feb. 21, 2002

(54) DOCUMENT MARKUP LANGUAGE AND SYSTEM AND METHOD FOR GENERATING AND DISPLAYING DOCUMENTS THEREIN

(76) Inventors: RONALD E. FORTIN, EXETER, RI (US); LOUIS R. BERSHAD, JAMESTOWN, RI (US); BRIAN T. BRADY, WARWICK, RI (US)

Correspondence Address: PETER J GORDON, WOLF GREENFIELD AND SACKS, 600 ATLANTIC AVENUE, BOSTON, MA, 02210

(21) Appl. No.: 09/012,293

(22) Filed: Jan. 23, 1998

(51) Int. Cl. G06F 17/00

(52) U.S. Cl. 707/513

(57) ABSTRACT

The present invention uses a markup language that defines elements which improve the ability of users to view more complex documents, particularly graphical documents, such as those based on data generated by computer-aided design, computer-aided software engineering, or other data modeling tools. An electronically published document contains descriptive markup defining several tags. Elements defined by tags are instantiated as objects which are responsive to user input. These tags define elements which are interpreted to define a diagram containing a plurality of layers. Each layer contains several graphical objects. An object may have associated with it a menu of actions or hypertext links. A computer system or computer-implemented process processes such an electronically published document and generates on a computer display the diagram defined by the descriptive markup. The different layers of the document may be displayed selectively. Also, the view of the diagram may change using a zoom function, or it maybe refreshed, i.e., redisplayed, or the electronically published document may be reloaded and reprocessed. One or more objects may be selected. Selection of objects may invoke a display of a menu of selectable actions which are associated with that object. These actions may include one or more hypertext links.

### FIELD OF THE INVENTION

The present invention is related to the generation and processing of documents in a markup language.

### BACKGROUND OF THE INVENTION

Markup languages, such as the standard generalized markup language (SGML), and variants thereof, have been used previously in electronic publishing. One advantage of a markup language, rather than a particular data file format, is that a markup language defines elements which describe the structure of a document. In such a document, markup language elements include tags and their content, such as text, graphics, pointers to other documentary or other media. Tags may include start tags, end tags, or empty tags. A start tag begins a markup element. An end tag ends the corresponding markup element. These start and end tags generally define the boundaries of an element. An empty tag is understood as being both a start and an end tag with no content. These tags and their content are interpreted when the document is rendered to display the content of the document according to a desired format. One form of markup language is the hypertext markup language (HTML) which is commonly used in a client-server system to distribute electronic documents. These documents are typically transferred using the hypertext transfer protocol (HTTP) over the Internet or other computer network using the TCP/IP protocol. Other markup languages include the virtual reality modeling language (VRML) and HyTime, among other markup languages.

Markup languages generally have been used to define the structure of electronic documents. When graphics are used within these documents, they are imported into such documents by using a tag, such as the “<IMG>” tag in HTML. This tag uses a reference to a data file in some graphic file format to import the image data. Additionally, such markup languages typically have a mechanism to provide a hypertext link from a location in one document to a location in another document.

While markup languages have many useful features, they also have some limitations. For example, in HTML, each element can have a hypertext link to only one other element or file. Similarly, in HTML, graphics require an image file already to be created. The entire image is displayed. HTML browsers generally do not allow selective viewing of only a portion of an image or otherwise allow a browser to “zoom” in and out on an image.

Further, these HTML documents contain static content, and when updated, need to be reloaded from a server. In addition, updated HTML documents need to be created manually and deposited in server directories, creating additional work for a document administrator.

### SUMMARY OF THE INVENTION

The present invention uses a markup language that defines elements which improve the ability of users to view more complex documents, particularly graphical documents, such as those based on data generated by computer-aided design, computer-aided software engineering, or other data modeling tools. Further, one embodiment of the present invention allows a display of an electronic document to dynamically change in response to user input.

Accordingly, one aspect of the present invention is an electronically published document containing descriptive markup defining several tags. These tags define elements which are interpreted to define a diagram containing a plurality of layers. Each layer contains several graphical objects. An object may have associated with it a menu of actions or hypertext links.

Another aspect of the invention is a computer system or computer-implemented process which processes such an electronically published document and generates on a computer display the diagram defined by the descriptive markup. Elements of the electronic document are instantiated as objects which may be responsive to user input. These objects may be graphics objects which respond to events received from the user through the computer system. The different layers of the document may be displayed selectively. Also, the view of the diagram may change using a zoom function, or it may be refreshed, i.e., redisplayed, or the electronically published document may be reloaded and reprocessed. One or more objects may be selected. Selection of objects may invoke a display of a menu of selectable actions which are associated with that object. These actions may include one or more hypertext links.

Another aspect of the invention is a computer system for generating and displaying electronically published documents having a plurality of markup elements, the computer system comprising a display configured to display an input electronic document to a user and a processor which processes the input electronic document and generates a first image on the display of the computer system on the basis of the plurality of markup elements, wherein the processor is responsive to an input of the user to generate a second image of the input electronic document based on the user input.

In another aspect of the invention, the processor instantiates a first object corresponding to at least one of the plurality of markup elements. In another aspect at least one of the plurality of markup elements is a graphics element. In another aspect of the invention the processor instantiates an object corresponding to the graphics element.

Another aspect of the invention is a computer system wherein the processor instantiates a parser object configured to parse the input electronic document. In another aspect of the invention is a computer system wherein the processor instantiates a second object having a defined relation to the first object and is adapted to change a representation of the second object when a representation of the first object is changed. In another aspect of the invention, the processor instantiates a view handler object that responds to user input.

In another aspect of the invention the processor instantiates a parser object configured to parse the input electronic document and wherein the processor instantiates a diagram object based on the plurality of markup elements. In yet another aspect of the invention, wherein the diagram object includes a plurality of shape objects which represent graphic markup elements. In another aspect of the invention, the diagram object includes a plurality of layers with which are associated each of the plurality of shape objects.

In another aspect of the invention is a computer system according wherein the processor is adapted to a display one or more of the plurality of layers.

In yet another aspect of the invention, selection of a graphics object by a user invokes a menu of selectable actions.

In another aspect of the invention is a computer system wherein one or more of the selectable actions have an associated link to another input electronic document. In another aspect of the invention, the first object is responsive to the user input and wherein the processor generates an updated display of the first object based on the user input.

Another aspect of the invention is a computer system wherein the first object is associated with a graphics element, and is responsive to a function and wherein the function provides the updated display is different than an original display of the first object. Another aspect of the invention is computer system wherein the processor instantiates a second graphics object having a defined relation to the first graphics object and is adapted to change a representation of the second graphics object when the original display is updated.

Accordingly, another aspect of the present invention is an electronically published document comprising a computer readable medium with computer logic stored thereon and defining descriptive markup defining several tags, wherein each tag defines an element, wherein an element is interpreted to define a diagram containing a plurality of layers, wherein each layer contains several graphical objects, and wherein each object may have associated therewith a menu of actions or hypertext links.

Another aspect of the invention is a computer system or computer-implemented process which processes such an electronically published document and generates on a computer display the diagram defined by the descriptive markup, wherein the different layers of the document are displayed selectively.

Accordingly, another aspect of the invention is a computer-readable medium having computer-readable logic stored therein defining a data structure for representing an electronic document, the data structure comprising means defining the electronic document as a plurality of markup elements defining a first one of the plurality of markup elements wherein the one includes an attribute expressing an inheritance relation to a second element that is at a same hierarchical level as the first one.

Another aspect of the invention is a computer-readable medium wherein the one of the plurality of markup elements may be instantiated as an object by a computer process.

Another aspect of the invention is a computer-readable medium wherein the one of the plurality of markup elements is a graphics element.

Another aspect of the invention is a computer-readable medium the data structure further comprising means for defining a menu having selections associated with the one, wherein each element has an associated link.

Another aspect of the invention is a computer-readable medium wherein the first and second elements are graphical elements, and wherein an interpreted display of the first element depends on attributes of the second object.

Another aspect of the invention is an object-oriented computer system for generating and displaying an electronic document including a plurality of markup language elements, the system comprising of a parser object class wherein an instance of the parser object class comprises a method adapted to parse the electronic document, a diagram object class wherein an instance of the diagram object class is generated by the parser object class and comprises a plurality of shape objects representing graphic elements and a view handler object class wherein an instance of the view handler object class comprises a method for manipulating the diagram object used by the parser object class to generate an updated diagram object.

Another aspect of the invention is an object-oriented system wherein a first instance of the shape object class has a defined relation to a second instance of the shape object class and is adapted by a change in the second instance.

Another aspect of the invention is a method for generating and displaying an electronically-published document having a plurality of markup elements, the method comprising the steps of parsing an input electronic document, generating a display of the input electronic document, responding to a user input by generating a different display of the electronic document based on the user input.

Another aspect of the invention is a method wherein the parsing step includes the steps of reading a markup element of the input electronic document and instantiating a first object associated with the markup element.

Yet, another aspect of the invention is a method wherein the responding and generating step includes the steps of determining a change in the first object based upon the user input determining a change in a second object based on the change in the first object and generating a display of the changed first and second objects.

Another aspect of the invention is a method wherein the first and second objects are graphics objects and the change in the first object is a change in zoom.

Another aspect of the invention is a method wherein the input electronic document comprises a plurality of markup elements with at least one of the markup elements being a graphics element, and wherein the responding step includes the steps of displaying the graphics element and generating, in response to the user input, a different display of the graphics element.

Another aspect of the invention is a method for processing an electronically-published document having a plurality of markup elements, the method comprising the steps of parsing an input electronic document, reading a plurality of markup elements of the input electronic document, instantiating objects corresponding to the plurality of markup elements, and generating output and accepting inputs, by at least one object to a user.

Further features and advantages of the present invention as well as the structure and operation of various embodiments of the present invention are described in detail below with reference to the accompanying drawings.

### BRIEF DESCRIPTION OF THE DRAWINGS

In the drawings,

FIG. 1 is a data flow diagram illustrating a computer network as an example embodiment in which the present invention may be used;

FIG. 2 is a module dependency diagram of a display system in accordance with one embodiment of the present invention;

FIG. 3 is a state diagram of a program for displaying a document;

FIG. 4 is a state diagram of the state of servicing user interface events in FIG. 3;

FIG. 5 is an object model of the diagram object in FIG. 2;

FIG. 6 is an object model of the shape object class illustrated in FIG. 5;

FIG. 7 is an object model of the view handler shown in FIG. 2;

FIG. 8 is a display generated from the sample document of Appendix II;

FIG. 9 is a display generated from the sample document of Appendix III;

FIG. 10 is a display of a document generated by Appendix III;

FIG. 11 is a display generated from the sample document of Appendix IV;

FIG. 12A is a diagram of an interface for allowing zooming of the displayed diagram;

FIG. 12B is a diagram of an interface for allowing selection of layers of the diagram;

FIG. 13 is a display generated from the sample document of Appendix V;

FIG. 14 is a display generated using selected layers from the display of FIG. 13;

FIG. 15 is a display generated with all selected layers of the document of Appendix V;

FIGS. 16A-16F are parts of an enlarged view of FIG. 7; and

FIGS. 17A-17H are parts of an enlarged view of FIG. 5.

### DETAILED DESCRIPTION

The present invention will be more completely understood through the following detailed description which should be read in conjunction with the attached drawing in which similar reference numbers indicate similar structures. All references cited herein are expressly incorporated by reference.

Electronically published documents may be using descriptive markup, i.e., tags, which define a hierarchical structure of a plurality of elements. Such a markup language is the standard generalized markup language (SGML). A document may be represented using a structure that is defined as a document type within the SGML standard. The document type definition for a markup language used in one embodiment of the present invention is found in Appendix I, which is incorporated herein by reference. Sample documents in this language are in Appendices II, III, IV and V, which are incorporated by reference.

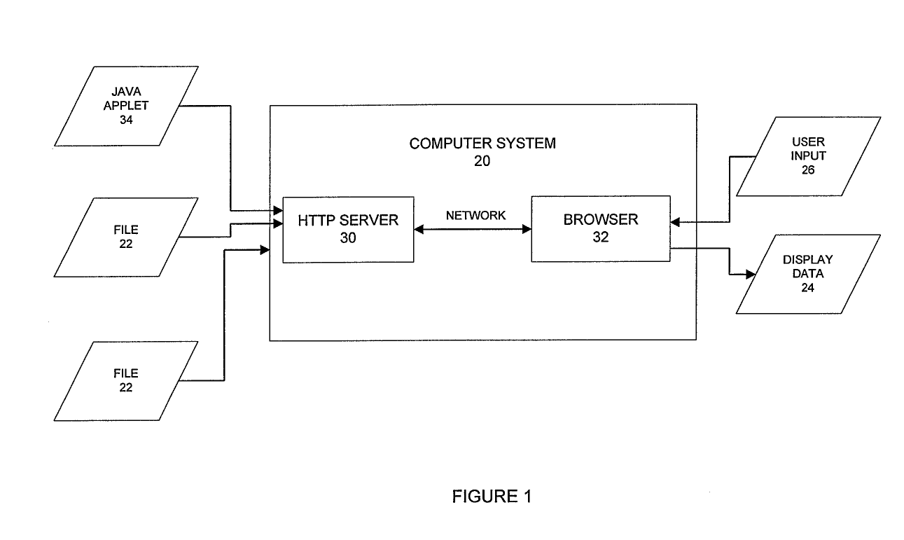

Referring now to FIG. 1, one embodiment of the present invention will now be described. It should be understood that there are several different embodiments which are possible, and that the invention is not limited to the one described.

FIG. 1 illustrates a computer system 20 which receives as one input a data file 22 which contains a document in a markup language, such as the language of the document type shown in Appendix I. The computer system 20 generates display data 24 and processes user requests 26.

A suitable computer system 20 typically includes an output device which displays information to a user. The computer system includes a main unit connected to the output device and an input device, such as a keyboard. The main unit generally includes a processor connected to a memory system via an interconnection mechanism. The input device is also connected to the processor and memory system via the connection mechanism, as is the output device.

It should be understood that one or more output devices may be connected to the computer system. Example output devices include a cathode ray tube (CRT) display, liquid crystal displays (LCD), printers, communication devices such as a modem or network interface, and audio output. It should also be understood that one or more input devices may be connected to the computer system. Example input devices include a keyboard, keypad, track ball, mouse, pen and tablet, communication device, audio input and scanner. It should be understood the invention is not limited to the particular input or output devices used in combination with the computer system or to those described herein.

The computer system 20 may be a general purpose computer system which is programmable using a high level computer programming language, such as the “C”, “C++”, and “Java” programming languages (Java is a trademark of Sun Microsystems, Inc.). Other programming languages are available. The computer system may also be specially programmed, special purpose hardware. In a general purpose computer system, the processor is typically a commercially available processor, of which the series x86 processors, such as the Pentium II processor with MMX technology available from Intel and similar devices from AMD and Cyrix, and the 680X0 series microprocessors available from Motorola are examples (Pentium and Intel are registered trademarks of the Intel Corporation, MMX is a trademark of the Intel Corporation, AMD is a trademark of Advanced Micro Devices, Inc., Cyrix is a registered trademark of the Cyrix Corporation, and Motorola is a trademark of Motorola, Inc.). Many other processors are available. Such a microprocessor executes a program called an operating system, of which the Windows NT, Windows 95, UNIX, DOS, VMS, ULTRIX, IRIX, Solaris, VxWorks, OS/Warp, MacOS, and IntranetWare operating systems are examples (Windows, DOS, and Microsoft are registered trademarks; and Windows NT is a trademark of the Microsoft Corporation, VMS and ULTRIX are trademarks of Digital Equipment Corporation, IRIX is a registered trademark of Silicon Graphics, Inc., Solaris is a registered trademark of Sun Microsystems, OS/Warp is a registered trademark of International Business Machines, Inc., and MacOS is a registered trademark of the Apple Corporation). The operating system controls the execution of other computer programs and provides scheduling, debugging, input/output control, accounting, compilation, storage assignment, data management and memory management, and communication control and related services. The processor and operating system define a computer platform for which application programs in high-level programming languages are written.

A memory system typically includes a computer readable and writeable nonvolatile recording medium, of which a magnetic disk, a flash memory and tape are examples. The disk may be removable, such as a floppy disk or removable hard drive, or permanent, such as an internal hard drive. A disk has a number of tracks in which signals are stored, typically in binary form, i.e., a form interpreted as a sequence of ones and zeros. Such signals may define an application program to be executed by the microprocessor, or information stored on the disk to be processed by the application program. Typically, in operation, the processor causes data to be read from the nonvolatile recording medium into an integrated circuit memory element, which is typically a volatile, random access memory such as a dynamic random access memory (DRAM) or static memory (SRAM). Other memory types are available. The integrated circuit memory element allows for faster access to the information by the processor than does the disk. The processor generally manipulates the data within the integrated circuit memory and then copies the data to the disk when processing is completed. A variety of mechanisms are known for managing data movement between the disk and the integrated circuit memory element, and the invention is not limited thereto. It should also be understood that the invention is not limited to a particular memory system.

It should be understood the invention is not limited to a particular computer platform, particular processor, or particular high-level programming language. Additionally, the computer system 20 may be a multiprocessor computer system or may include multiple computers connected over a computer network.

The present invention is also suitable for implementation in a network environment, such as the Internet or an Intranet, which connects a server 30 to a client or browser 32. The server 30 maybe a hypertext transfer protocol (HTTP) server which makes files 22, and possibly computer programs such as “java applets” 34, available to the browser 32. Java applets are programs implemented in the Java programming language, which is a well-known object-oriented language in the art of programming. There are many commercially available HTTP servers. Other file transfer protocols and servers may be used. The browser 32 may be any commercially available browser that has the ability to process markup language documents. For the purposes of processing java applets 32, the browser should be “java-enabled”, that is, the browser should be capable of executing programs written in the Java programming language. The Netscape Navigator browser, from Netscape Communications, Inc., and the Internet Explorer browser, from Microsoft Corporation, are examples of such a browser. The browser and the server generally communicate by transferring HTTP messages over the network, which typically uses the TCP/IP networking protocol. It is understood that other networking protocols may be used.

In one embodiment to be described, the “java applet” 34 is utilized by the browser 32 to process documents in the markup language in accordance with one embodiment of the present invention. It should be understood that the browser 32 could also be modified to process this markup directly, similar to how other extensions to the hypertext markup language (HTML) are processed. Further, it should be understood that the HTML language may be extended to support these features.

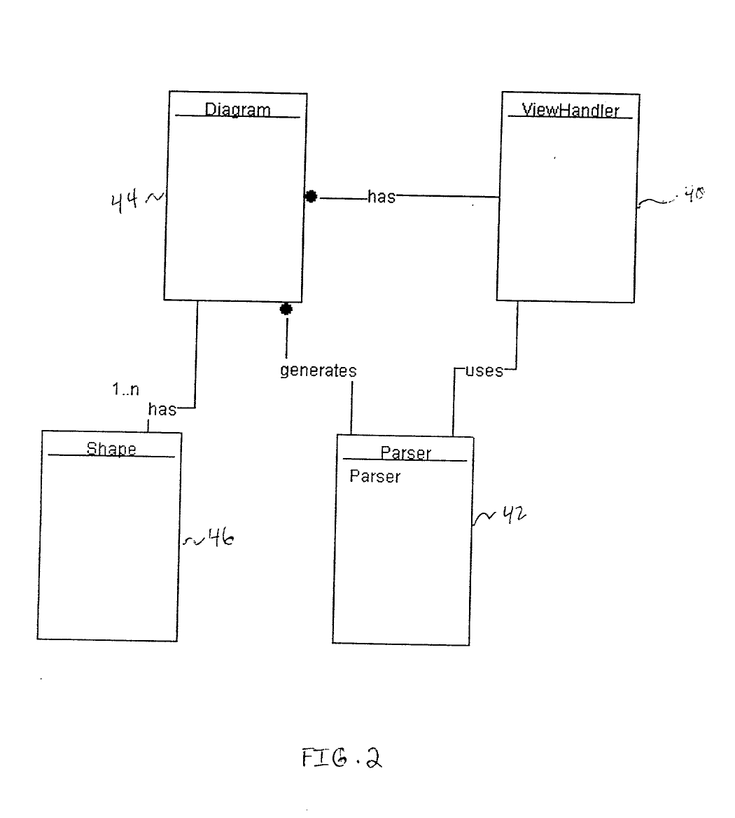

In order to process a document in the markup language in accordance with one embodiment of the invention, an object oriented system is implemented using a java programming language. This system has four primary object classes as shown in FIG. 2. These object classes are a view handler 40, a parser 42, a diagram 44 and a shape 46. The parser 42 generates the diagram 44. The view handler 40 is an object that has several methods associated with it to manipulate the diagram 44. Also, the view handler object 40 uses the parser object 42 to generate the diagram 44. The diagram has several shapes 46 associated with it, one for each graphical object defined in the diagram. A shape object is instantiated or generated for each of the graphical objects defined.

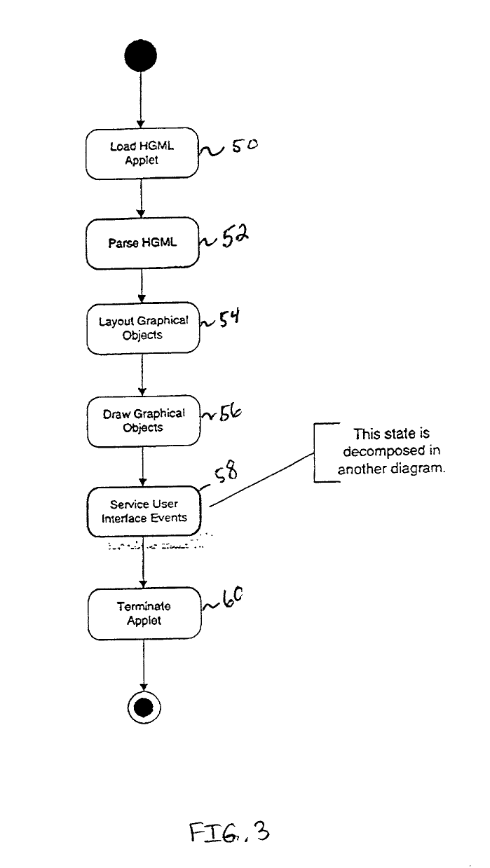

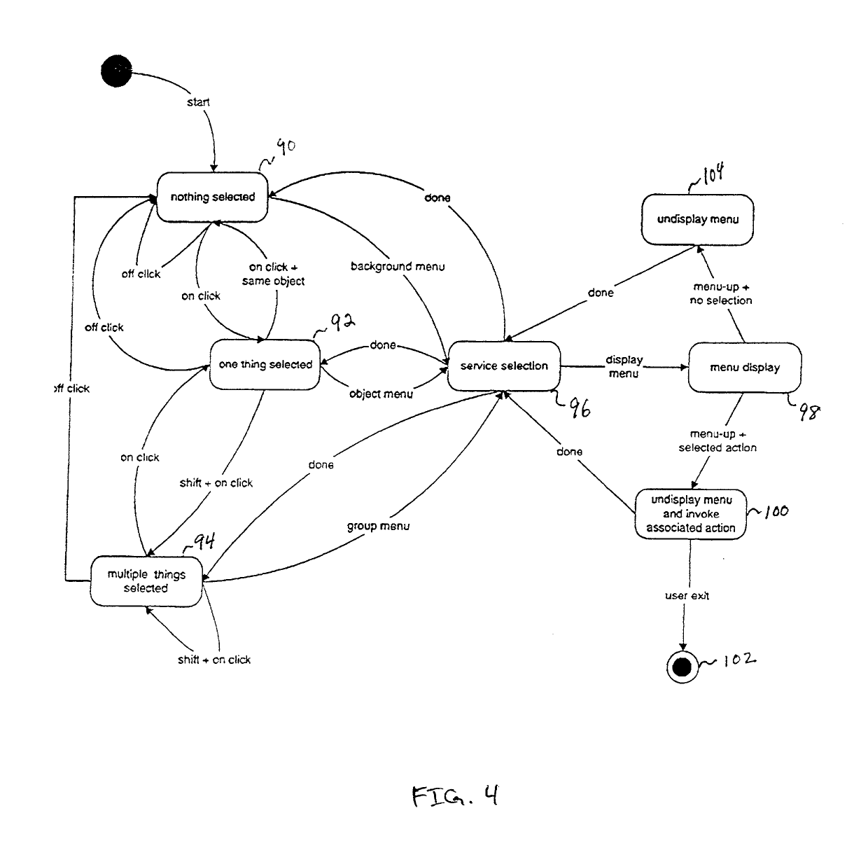

The state diagram of a program which generates and uses these objects will now be described in connection with FIG. 3. First, the java applet for processing this markup language is loaded by the browser in state 50. The applet accesses the file containing the markup language document and parses it in state 52. Parsing of the HGML document is done using standard markup language processing techniques using the document type definition (DTD) provided in Appendix I. A particular DTD may be defined by one or more grammar rules as shown in Appendix I. Given a set of grammar rules, a parser may be constructed that verifies the format of a document. Parser creation is well-known in the art of compiler theory. However, in one embodiment of the invention, the parser is instantiated as an object that parses an HGML document. Upon verification by the parser that the document is valid, the graphical objects defined by the document are then laid out in the display area in state 54. For example, referring to the document shown in Appendix II, a diagram having a size of 2,000 pixels by 2,000 pixels is first defined. Each graphical object, such as a rectangle with an identifier equal to “1,” is defined as an object, as will be described below, having a given position, size, color and fill. The position of each graphical object within the diagram is determined. The graphical objects are then drawn on the display in state 56. These graphical objects are instantiated in the memory of the computer system. Once objects are drawn on the display, user interface events can be serviced in state 58, which will be described in more detail in connection with FIG. 4. Because markup elements are instantiated as objects, the objects may be configured to respond to user events. Upon termination of the need to service user events, the applet is then terminated in state 60.

It should be understood that the invention is not limited to representation of processing and display of graphical objects, but any markup element may be represented by an object that receives events. It should also be known that the generation of these objects is not limited to applets or the Java programming language, but these objects may be generated by a program written in any other object-oriented programming language. Also, the objects may be implemented in any suitable programming language, such as a sequential programming language.

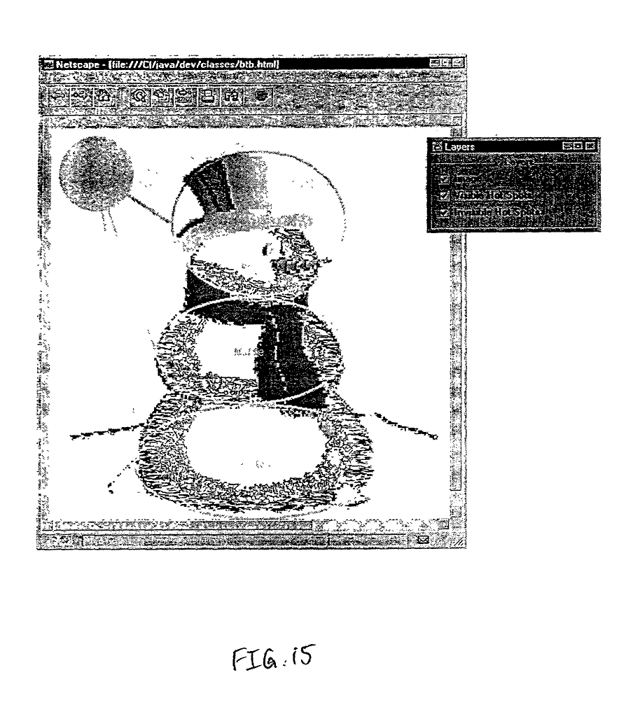

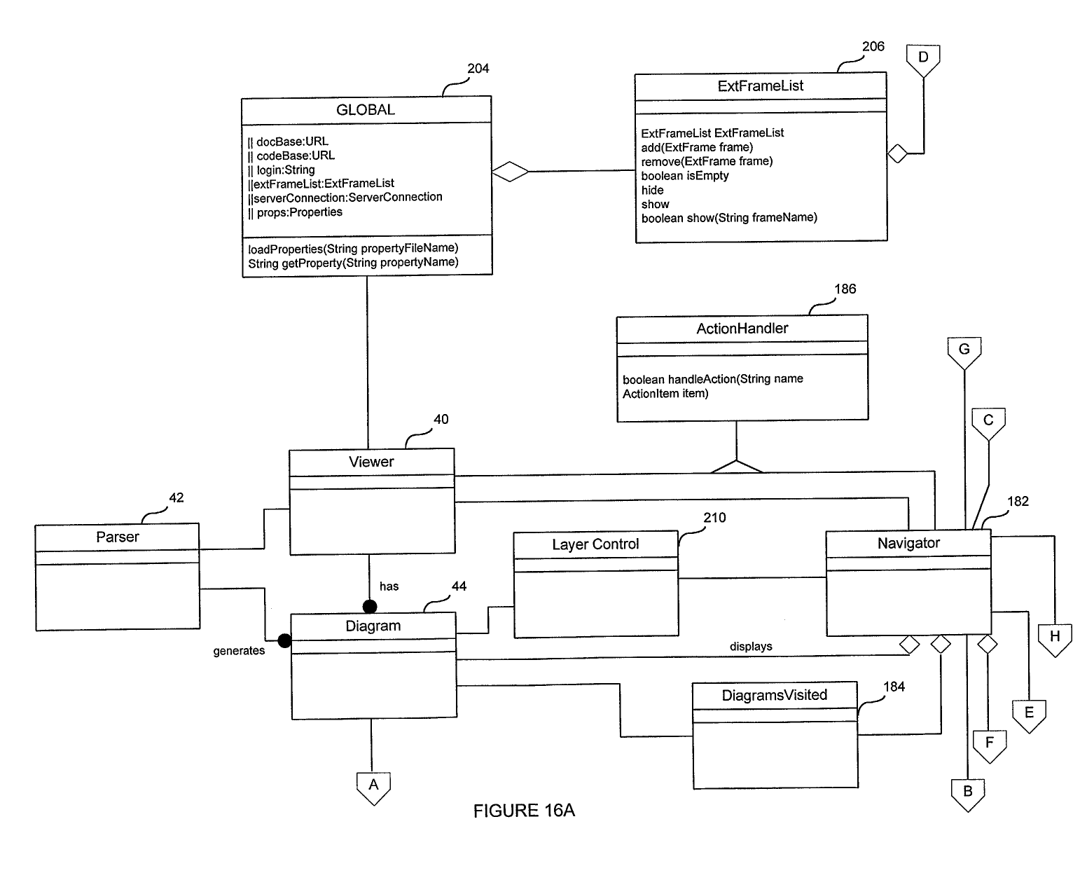

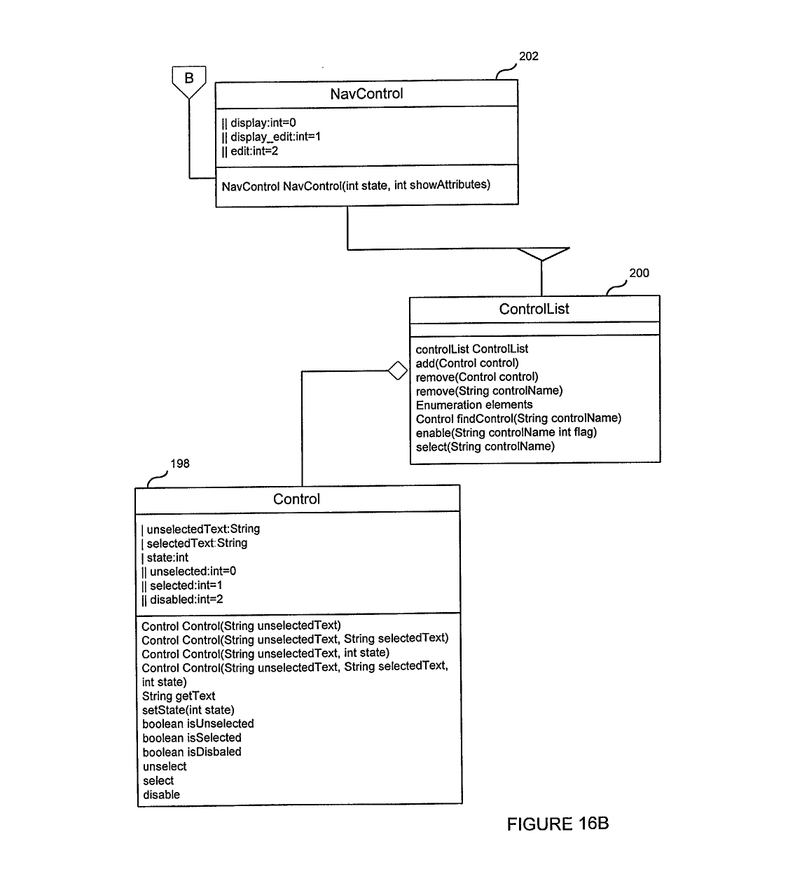

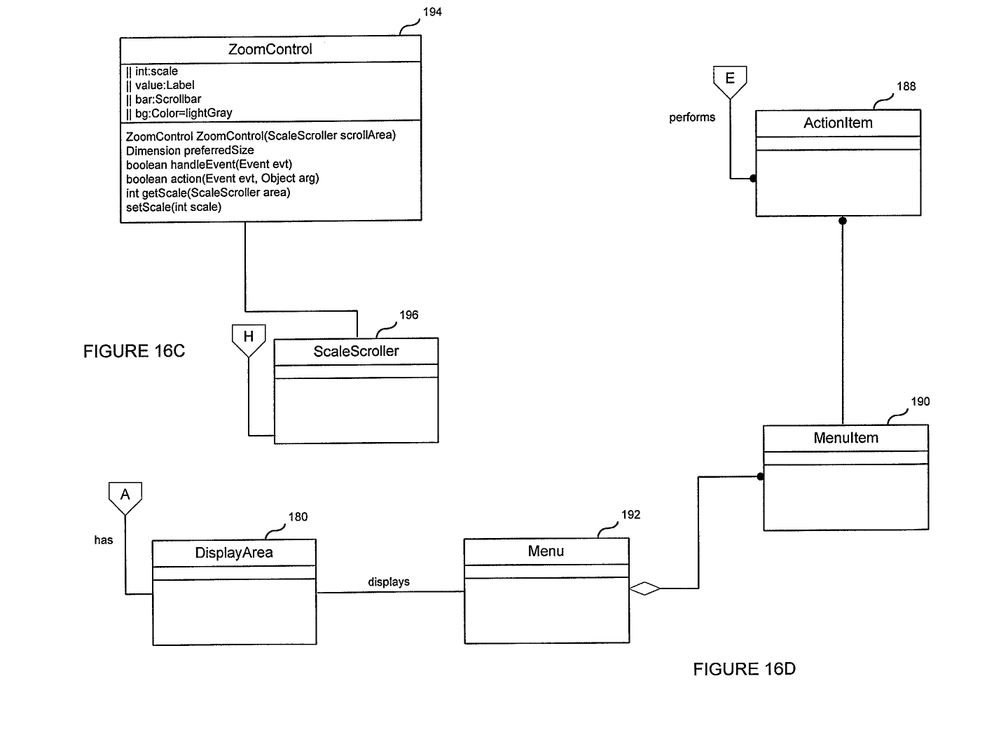

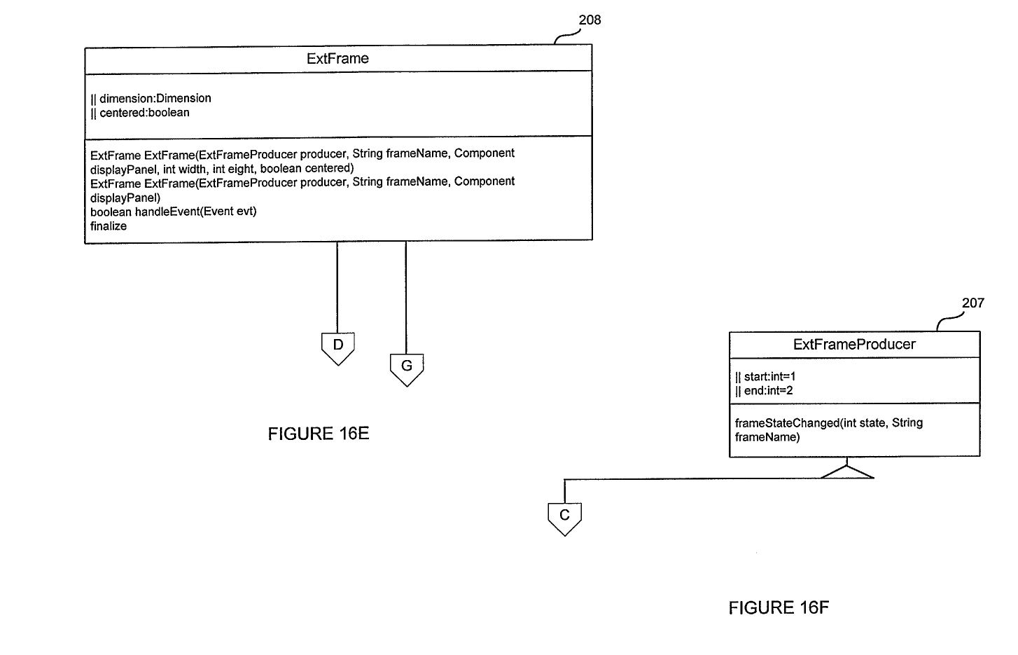

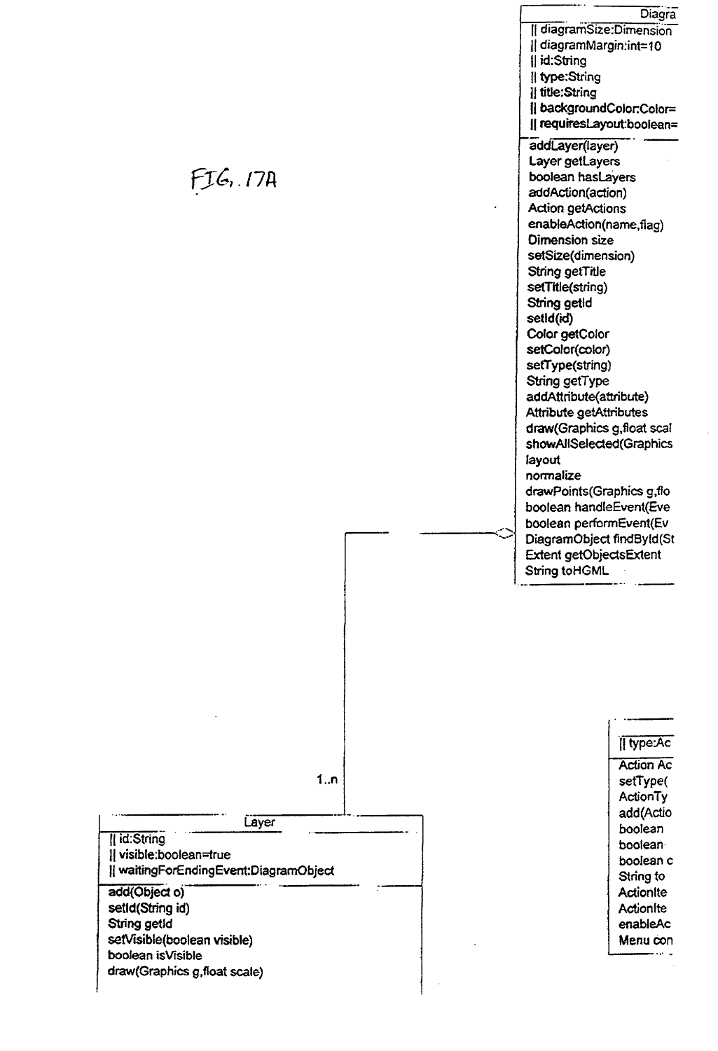

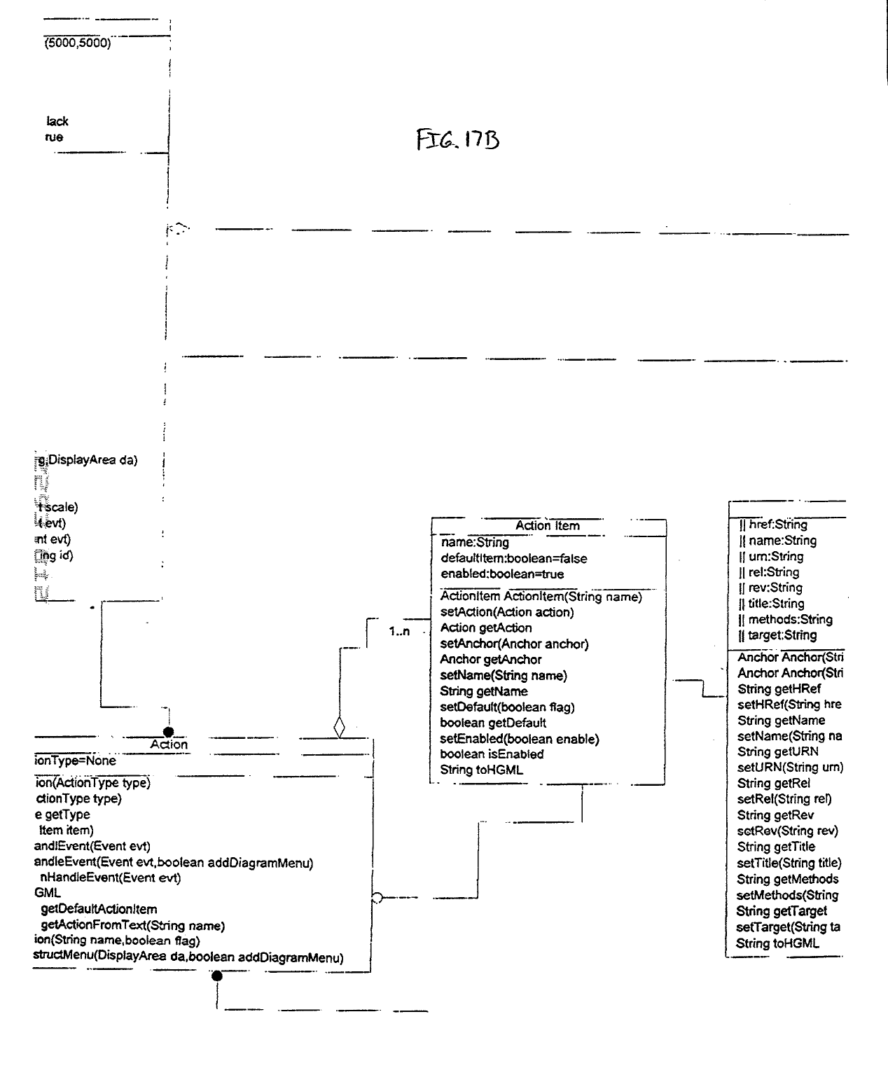

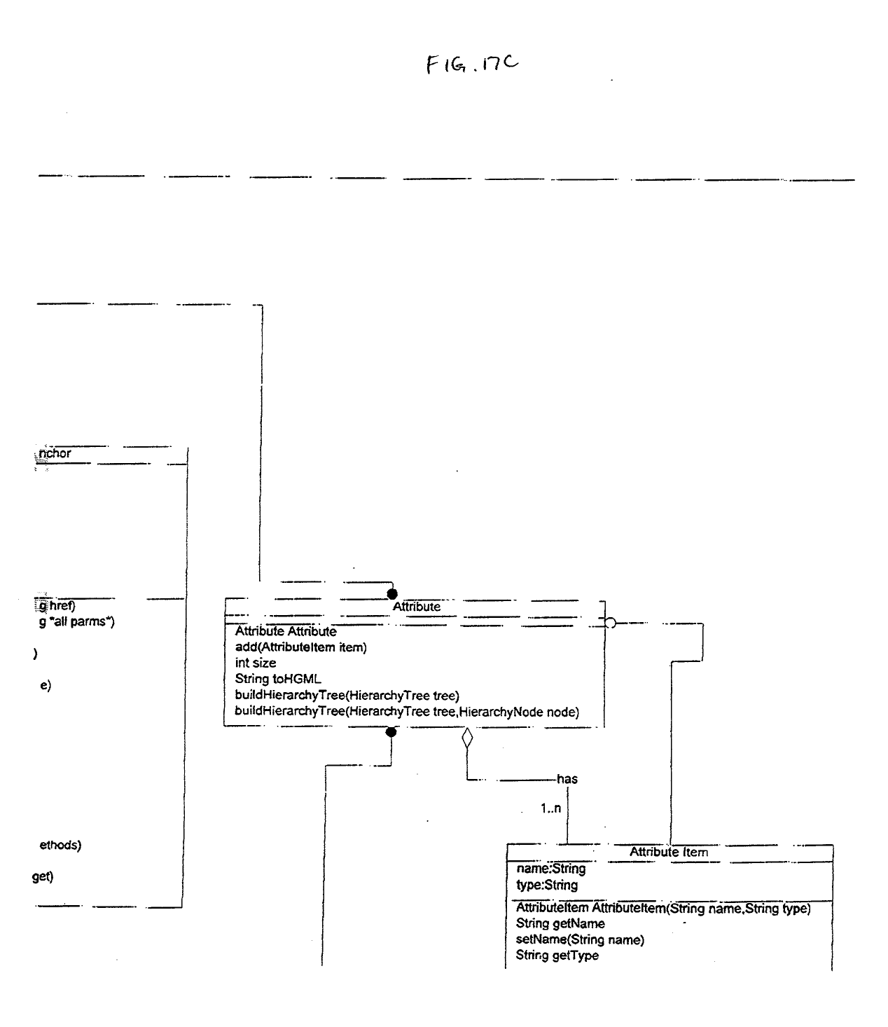

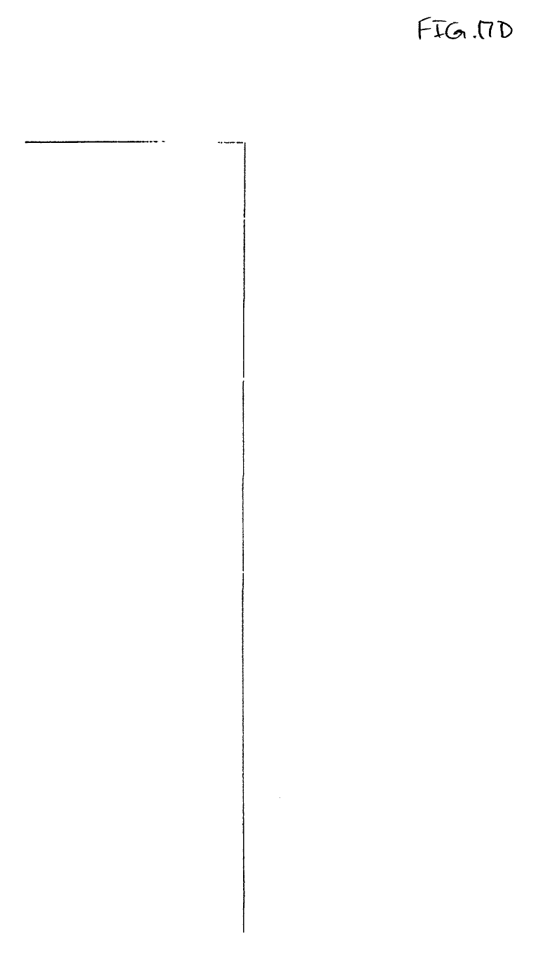

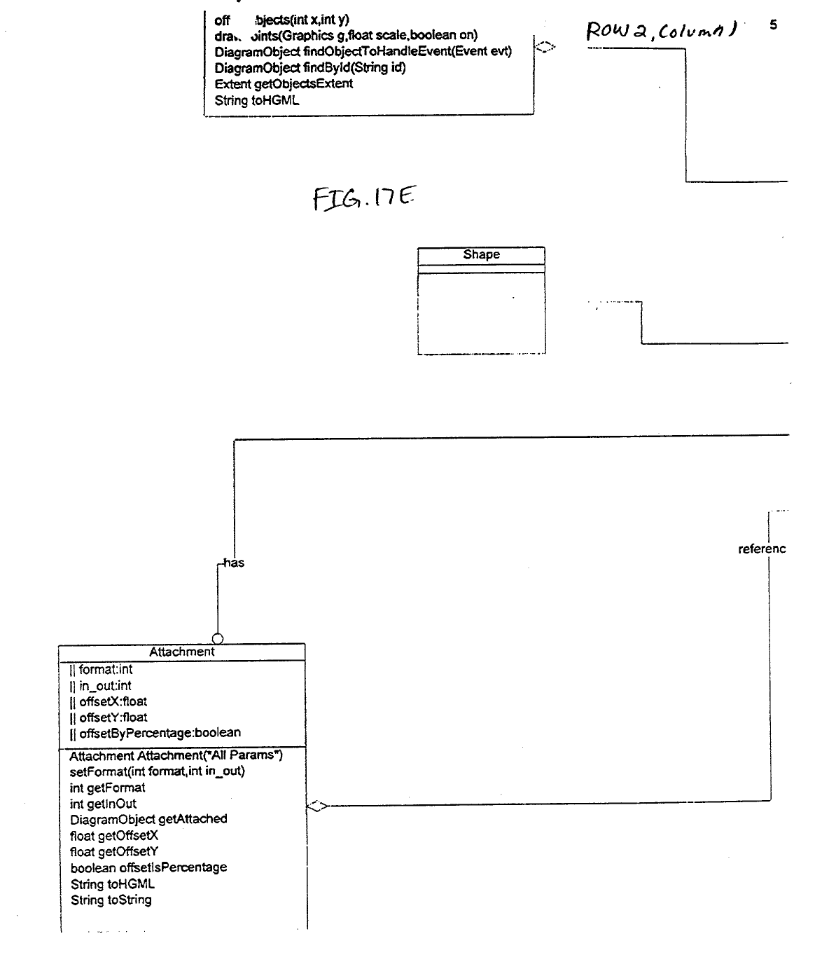

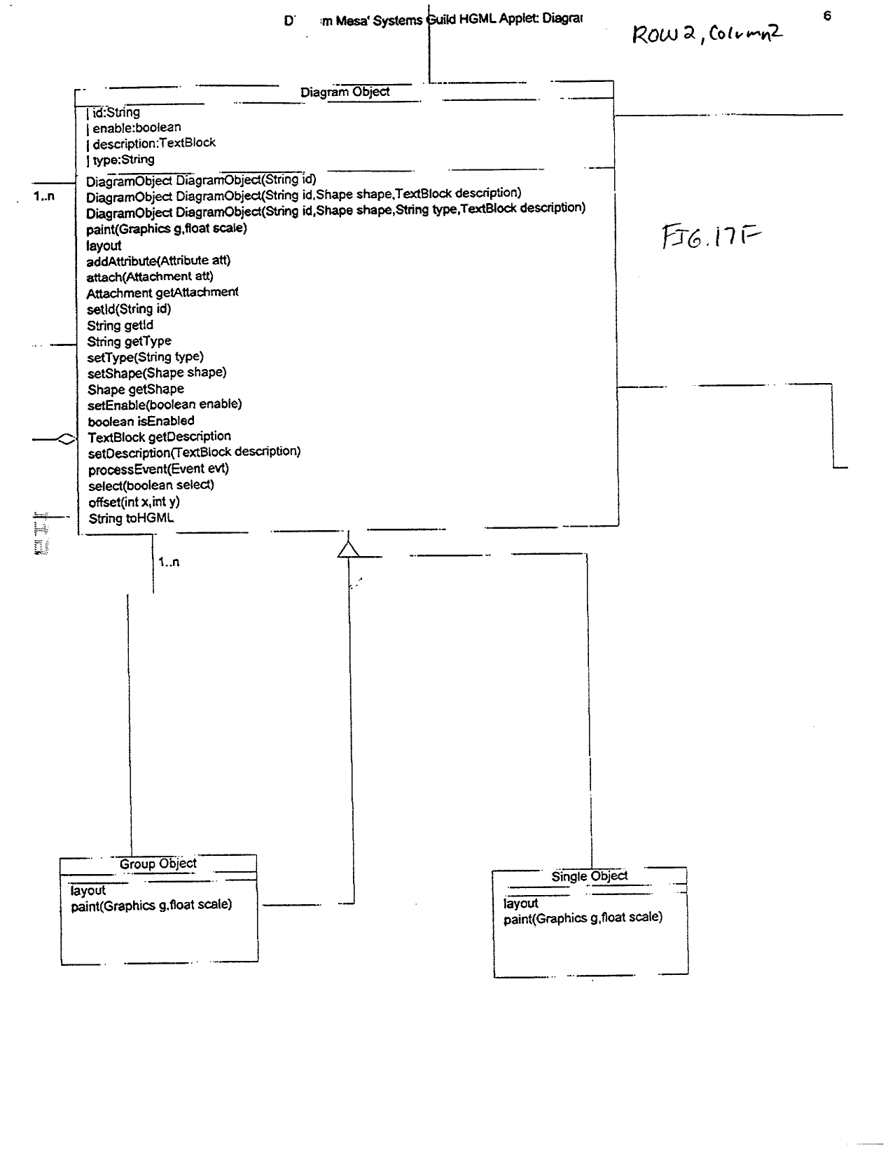

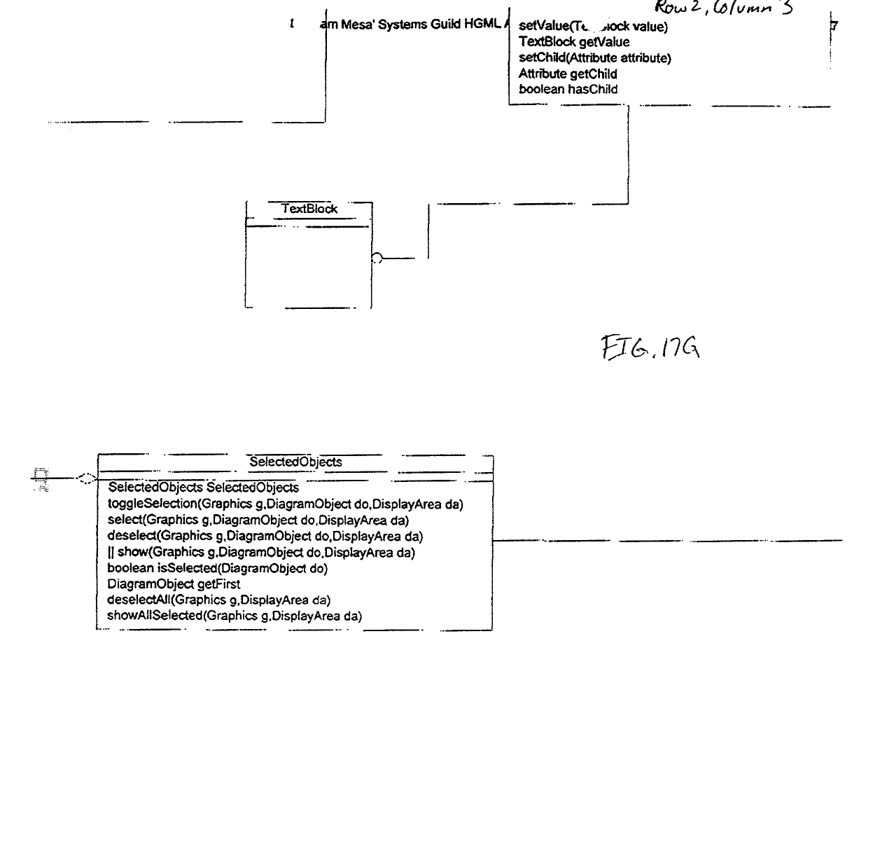

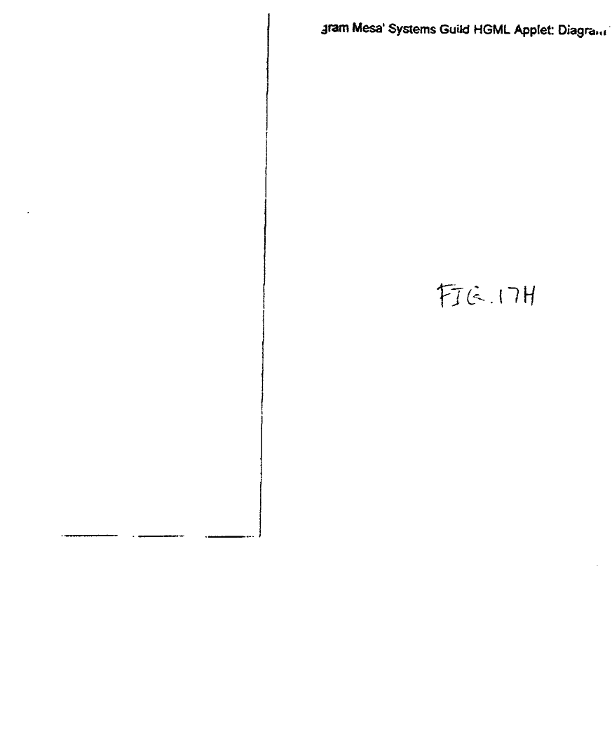

Before describing the servicing of user interface events in connection with FIG. 4, Some sample output displays will be described in connection with FIGS. 8-15 and their corresponding sample markup documents, shown in Appendices II-V.

FIG. 8 shows an organizational chart that may be generated using one embodiment of [a markup language] suitable for implementing the invention. This display corresponds to the document shown in Appendix II. Each of the displayed rectangles, such as 62, may be selected, as may names such as shown at 64. The selection of an object results in the display of a menu 66 which allows the selection of one of a multiple of uniform resource locators (URL). This menu of selections expands on the hypertext capability typically found in HTML documents which allows only one hypertext link assigned per HTML element.

A markup language of the kind described herein is typically useful for viewing data developed using a model-based development environment. Such models are used to describe function, behavior, process, system architecture, and several other aspects of a system. The model diagrams describe not only the system or process, but are used as a focal point of understanding for communicating information about, designing and supporting a system or process. Having multiple models, each representing different views of the system or process that can be browsed and navigated to other model data or perhaps to non-model data, is particularly helpful in model-based development environments.

Models also describe systems in a formalized methodology. This formalism allows models developed using some software tools to be converted to a markup language in accordance with the invention to allow them to be displayed and navigated. In general, certain types of data may be mapped to tags and attributes in the markup language. In addition, information regarding relationships among data can be used to generate hypertext links between elements.

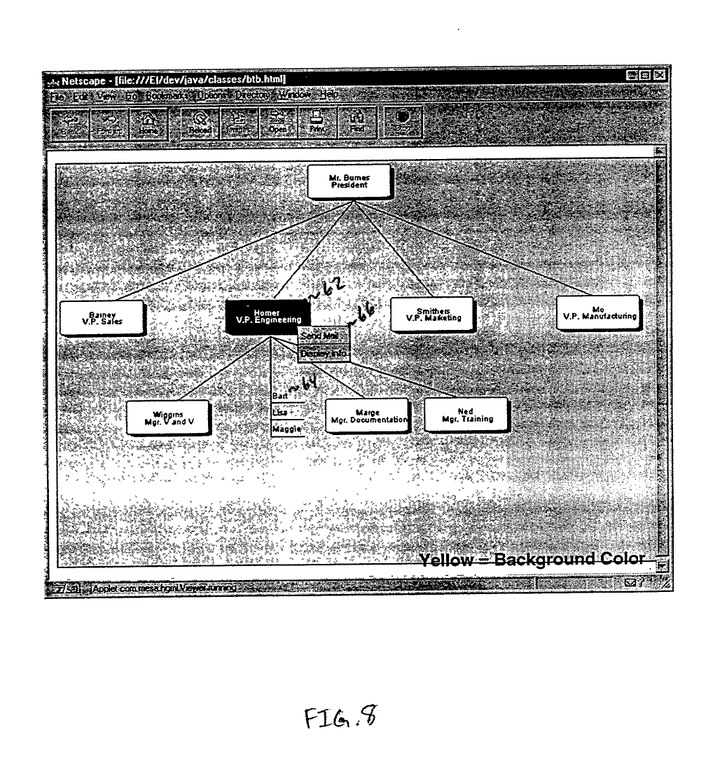

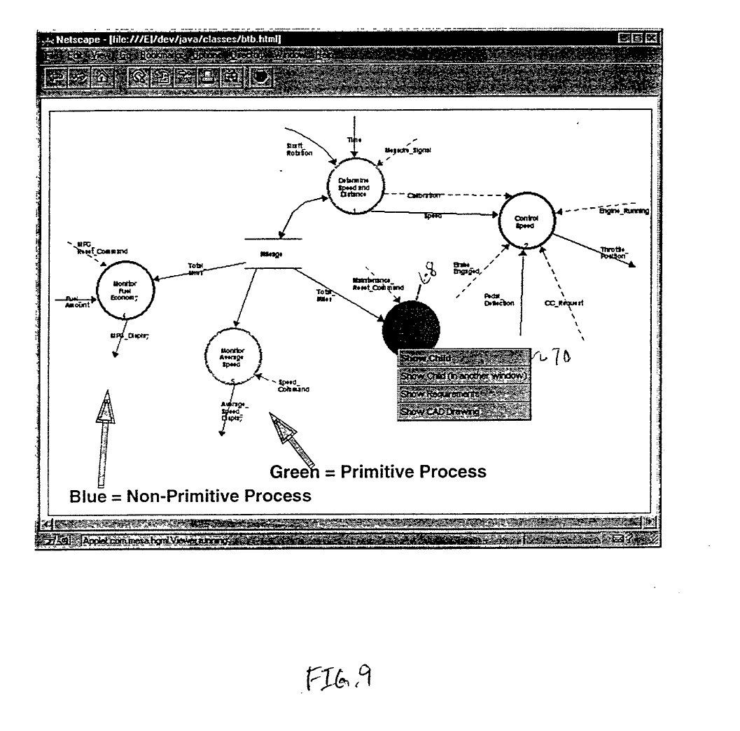

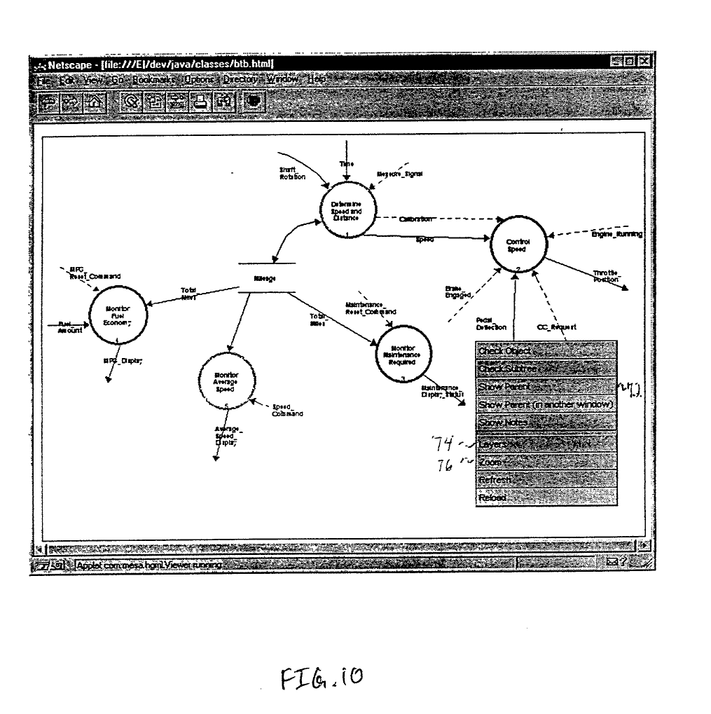

FIGS. 9 and 10, which are based on the document in Appendix III, illustrate how semantically important information, such as data from a database, can be used to generate informative displays. FIGS. 9 and 10 illustrate a data flow diagram which includes primitive and non-primitive processes. A non-primitive process may be decomposed into other processes. Such information may be derived from any original information used to generate such a data flow diagram, for example, a computer-aided design or computer-aided software engineering tool. For example, particular defined processes may be designated as primitive or non-primitive and have an associated shape and/or color. Such information may be represented in a markup language either by an element tag or an attribute. A non-primitive element will be decomposed into other elements. Typically, another drawing will exist for that decomposition. When a given object, e.g., 68, is selected, a menu 70 may be displayed in which a reference to the decomposition of that element may be one of the possible hypertext links, as illustrated by the command “Show Child.” Other information also may be available, such as a CAD drawing, a requirements document or personnel and pricing data.

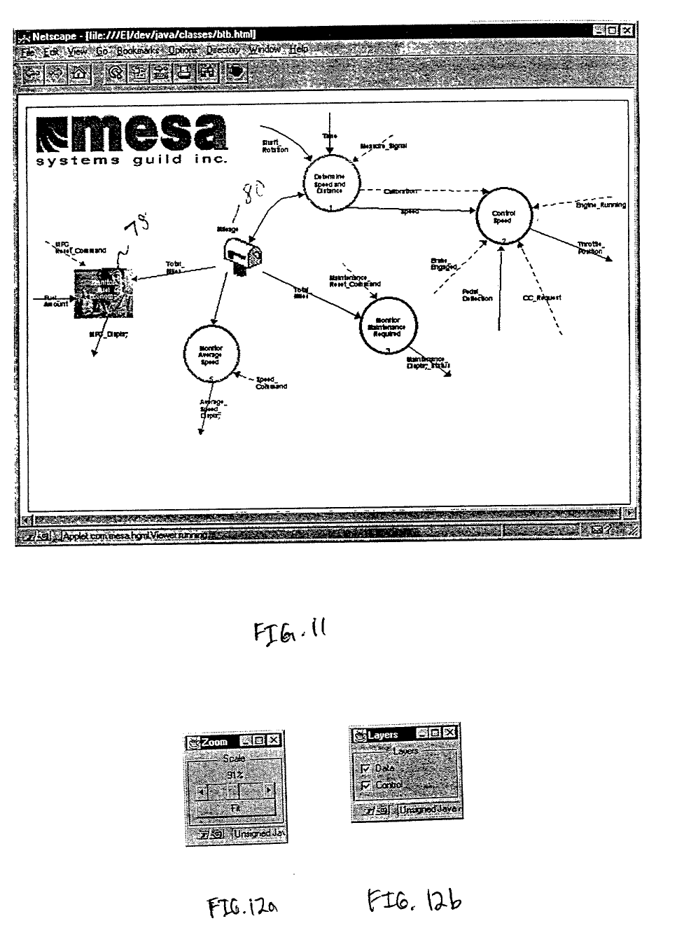

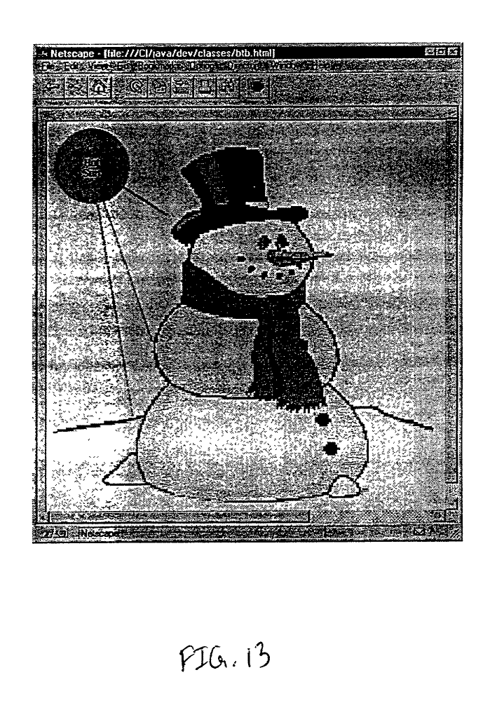

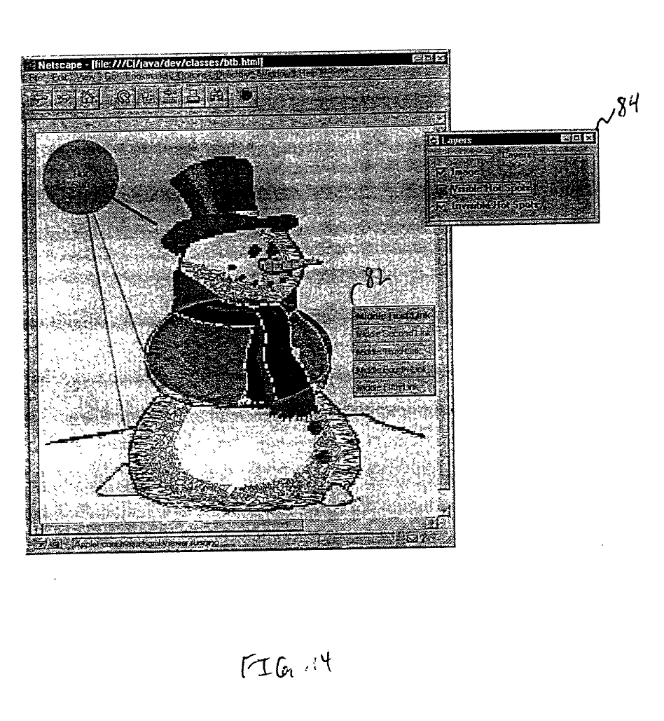

FIG. 10 illustrates the same document but with a menu that is displayed when “empty space” on the diagram is selected. Empty space signifies the space within the diagram which is not occupied by an object. Each diagram may have primitive operations associated with it, such as zooming, layering, refreshing and reloading, which can be selected using this menu. For example, reloading forces re-reading of the data from its source, refreshing causes a diagram to be repainted on the display. The menu also may allow for selection of a parent diagram, for which this model is a decomposition, as indicated at 72. If a zooming function is selected, a zooming window, shown in FIG. 12A, is displayed to the user, from which the user can control the size of the image they are viewing. This zooming function allows the defined documents to be redisplayed within the diagram area in a different size. The layer function presents a layer window to the user, from which the user can turn on and off the display of selected layers. Layers are defined by and dependent upon the markup language and whether layers are introduced in the authoring process. An example of layering will be described in more detail below in connection with Appendix V and FIGS. 13-15.

Some diagram shapes may be replaced by pictures or other graphics, such as shown at 78 and 80 in FIG. 11, and as defined by the document in Appendix IV.

Referring now to FIG. 13, the document of Appendix V can be used to display a simple image in a window. Using a language such as HTML, any particular point on this graphic may be associated with only a single action or uniform resource locator (URL). Additionally, the image that is loaded is one graphic file. The regions of the image which are associated with different URLs are commonly implemented using a mapping function which maps a pair of coordinate values to a single action to be performed. It is difficult to determine where the image map actually is on an image in an HTML document.

By using layers defined by the markup language of one embodiment of the present invention, the image may exist in one layer and image map areas may be implemented as another layer. Referring to FIG. 14, in the present invention, each region of the image also may be associated with a menu of possible hypertext links rather than a single link. This menu can be displayed as shown at 82. When the image map areas are implemented using a layer, the layers may be displayed or selected using the layering feature, which displays the menu 84. This capability can guide a user to different areas of interest.

Another aspect of the markup language in accordance with one embodiment of the invention is the attachment of objects, provided using the “attach” and “attach type” attributes. This aspect allows an object or graphic shape to be defined in relation to other objects in the diagram. The position, height and width can be defined in this way. This allows an object to be defined, for example, as being positioned in the center of another object and having one quarter of the size of the other object. A more complex example is the relation wherein one object is centered between two other objects having the same height as the first object, but a width equal to, e.g., one third the distance between the two other objects. This feature is useful in representing one object in relation to others so that when one is changed, the others are changed in the same manner.

Having now described some of the markup language features, and their corresponding display features, the state diagram for processing user interface events to provide these features will now be described in connection with FIG. 4.

A first state is the “nothing selected” state 90. Events which effect the state transitions are the user interface events such as a mouse click (either on or off) or the completion of an action or the selection of a menu item. Given a mouse click on an object, processing moves to the “one thing selected” state 92. If a click on the same object is received, the system returns to state 90. A click off of an object returns to the “nothing selected” state also. A shift key in combination with a mouse click on an object causes a transition to the “multiple thing selected” state 94. A shift key and click on additional items will add them to a list of selected items. A mouse click on one of the already selected items will eliminate it from the list. A mouse click off any of the selected items will cause a transition back to the “nothing selected” state 90. After a transition to the “one thing selected” state 92 or “multiple things selected” state 94, or a click on the background in the “nothing selected” state 90, appropriate menus are displayed, which involves a transition to the “service selection” state 96. In this state, either the background menu, menu for a selected object, or menu for the group of selected objects is displayed and there is a transition to the “menu display” state 98. On selection of a menu action, a transition is made to state 100 where the menu is removed from the display and the action associated with the menu item is invoked. If the menu action involves exiting the diagram, the process is terminated in state 102. Otherwise, processing returns to state 96. In state 98, if no menu item is selected, for example, by the receipt of a mouse click event outside the menu area, the menu is removed from the display in state 104. Processing then returns to the “service selection” state 96 which then reverts back to the “nothing selected”, “one thing selected” or “multiple things selected” states 90, 92 or 94, according to the objects selected which caused display of the menu in the first place.

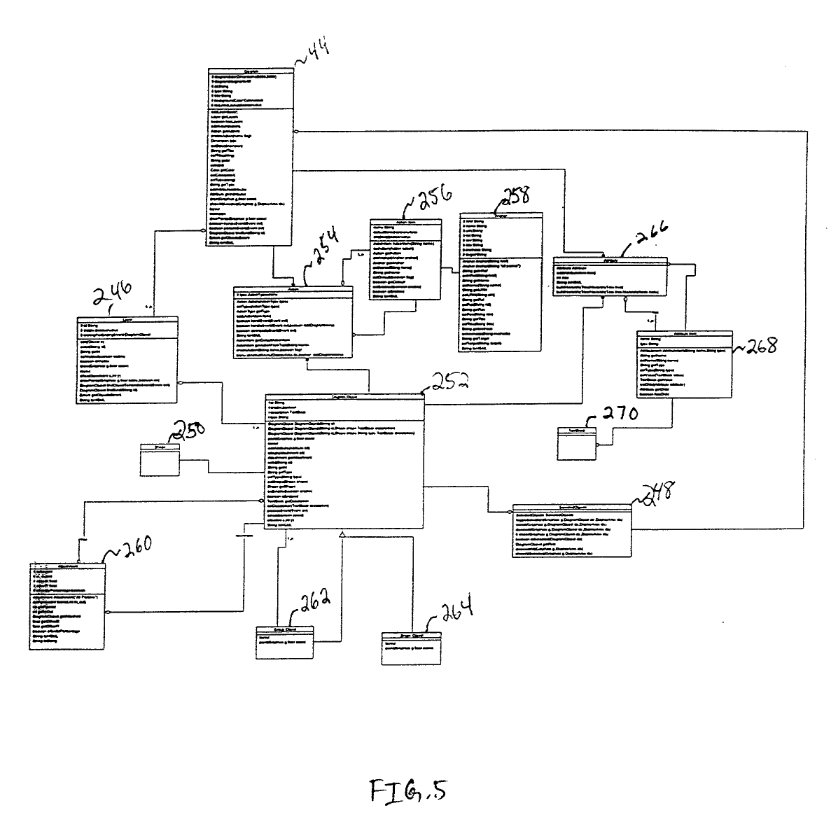

Having now described the general flow of the display and user interface interaction with documents in the markup language of the present invention, the layout of the graphical objects will now be described in connection with FIGS. 5 through 7. These Figs. are drawn according to the object modeling technique (OMT) which is well-known in the art of object oriented programming and described in Object-Oriented Modeling and Design by James Rumbaugh et al., Prentice-Hall, Inc., N.J., 1991, which is incorporated by reference.

FIG. 5 shows that the diagram 44 is comprised of layers 246 and selected objects 248. Each layer 246 is comprised of diagram objects 252. The diagram class is the root of all layers and diagram objects and is responsible for dispatching events from the display area to the appropriate diagram objects. Each diagram object has an associated shape 250. The list of selected objects 248 comprises a list of diagram objects 252. Each diagram object 252 is associated with actions 254. An action 254 may be comprised of several action items 256. An action item 256 is a uniform resource locator (URL) attached to a diagram object. It is displayed as a menu item in the display area and is executed by the navigator. If the navigator cannot handle the event, it is passed to the viewer. An action item has an associated anchor 258. An attachment 260 has an appearance defined by a diagram object. A group object 262 is associated with a number of diagram objects, while single object 264 is defined as a single diagram object 252. These are subclasses of the diagram objects 252. Diagram objects and diagrams may also have an attribute 266 associated therewith. An attribute is comprised of one or more attribute items 268. Each attribute item may have an associated text block 270.

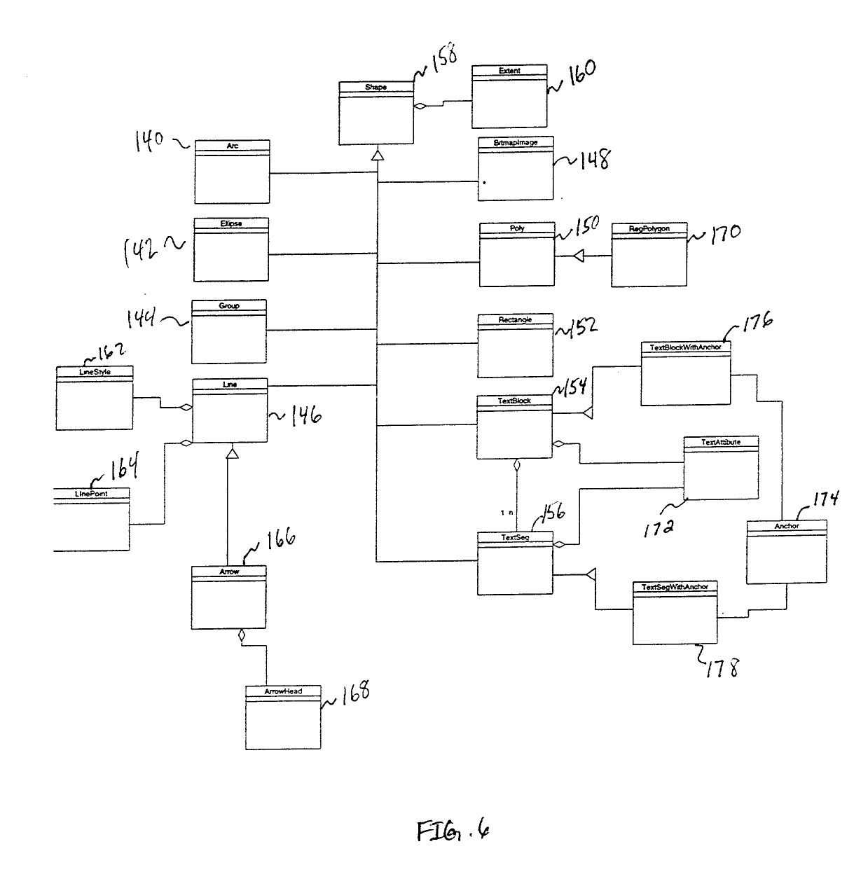

Referring now to FIG. 6 shows the different types of graphical objects which may be displayed. For example, there may be arc objects 140, ellipse objects 142, group objects 144, line objects 146, bit mapped images 148, polygons 150, rectangles 152, text blocks 154, and text segments 156. Other object types also may be displayed. Each one of these objects are subclasses of the shape object class 158. The shape is comprised of an extent object 160 which defines the area of pixels within the diagram that is considered part of the object. A line has associated with it a line style object 162 and a line point object 164. An arrow object 166 is a subclass of a line 146 and has an arrowhead 168. A regular polygon 170 is a subclass of a polygon 150. Text block 154 and text segments 156 use a text attribute 172. A text block 154 uses a text segment 156. An anchor object 174 is also used. It is part of a text block with anchor object 176 and text segment with anchor object 178. Each of the objects 176 and 178 respectively are subclasses of a text block 154 or text segment 156. Instances of each of these object classes are generated directly from the markup tags and associated attributes which indicate those objects.

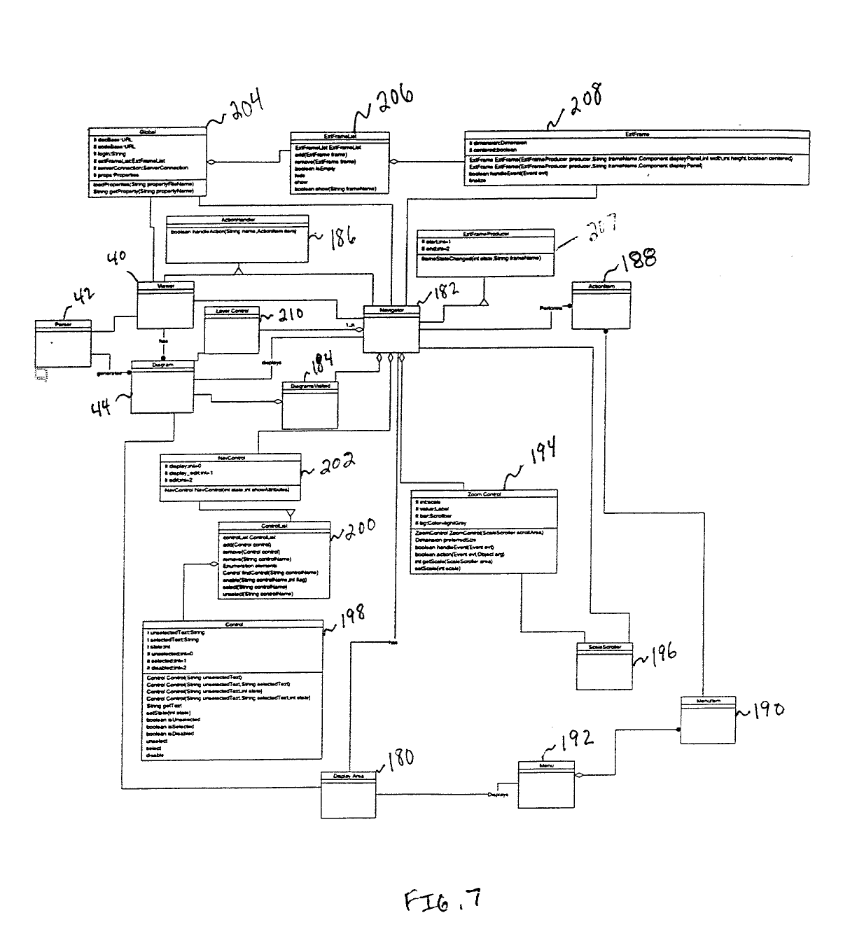

Referring now to FIG. 7, the display area 180 is the part of the display on which the diagram is drawn. This class is responsible for displaying the diagram objects, scaling the diagram objects and dispatching mouse events. The size of the display area is the size of the diagram times the scale. The navigator object class 182 is the container for the scale scroller and the display area. It uses the scale scroller to handle the scrolling of the diagram in the display area. The scale scroller class is responsible for handling the horizontal and vertical scroll bars. The scroll bars are only displayed if the display area is larger than can be displayed by the navigator. An diagrams visited object 184 keeps a list of diagrams that have been viewed with the viewer. When an action item calls a URL to display a diagram, this list is checked to determine whether the diagram was already retrieved. Is so, the existing diagram object is displayed instead of retrieving the URL.

The viewer 40 and navigator 182 are subclasses of the action handler object 186. The action handler is an abstract class. Any class that implements this class is allowed to service the action item request. The viewer class controls all interaction between the applet and the browser. Its responsibilities include creation of the diagram drawing space, communication with the HTTP server for retrieving files in this markup language and invocation of action items which are URL references. The navigator performs action items 188 which are elements within a menu item 190 which in turn are within a menu 192 which is displayed by a method of the display area object 180. A menu item represents the visual component of an action item. A control object 198 is an operation that can be performed by the navigator, which are included in a list maintained as an abstract class called a control list 200. Navigator 182 has a navigational control object 202 which is a subclass of the control list 200. It is the list of available or built-in menu options that are performed by the navigator. Some global variables are stored in a global object 204, such as the base URL of a document.

The navigator also has a zoom control object 194 which uses a scale controller 196. The zoom control displays a window to the user as shown in FIG. 12A which allows the user to change the zoom factor or scale of the diagram objects displayed in the display area. By changing the scale, the diagram is redisplayed in the new scale immediately.

A layer control object 210 is used to monitor which layers are active to be used by the navigator 182. It has a method for displaying a window which lists all the layers in the diagram. The user can select a layer to display it or deselect it in order not to display it. The display of the diagram is updated immediately upon a layer selection change.

The ExtFrameProducer 207 is an abstract class. Any class that implements this class is allowed to produce external windows, such as the zoom control and layer control classes. The ExtFrame class 208 is an external window container. It is used for displaying any pop-up window. The ExtFrame is added to an external frame list object 206. The frames are created by the class 207 or a subclass.

Each of the object classes has associated methods for creation of instances of these objects, reading and displaying these objects, updating the values describing the objects and deleting the objects. The implementation of such methods can be done by one of ordinary skill in the art and following the desired display and user interface actions above.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention as defined by the appended claims and equivalents thereto.

1. A computer system for generating and displaying electronically published documents having a plurality of markup elements, the computer system comprising:
a display configured to display an input electronic document to a user; and
a processor which processes the input electronic document and generates a first image on the display of the computer system on the basis of the plurality of markup elements, wherein the processor is responsive to an input of the user to generate a second image of the input electronic document based on the user input.

2. The computer system according to claim 1, wherein the processor instantiates a first object corresponding to at least one of the plurality of markup elements.

3. The computer system according to claim 1, wherein at least one of the plurality of markup elements is a graphics element.

4. The computer system according to claim 3, wherein the processor instantiates an object corresponding to the graphics element.

5. The computer system according to claim 2, wherein the processor instantiates a parser object configured to parse the input electronic document.

6. The computer system according to claim 2, wherein the processor instantiates a second object having a defined relation to the first object and is adapted to change a representation of the second object when a representation of the first object is changed.

7. The computer system according to claim 2, wherein the processor instantiates a view handler object that responds to user input.

8. The computer system according to claim 7, wherein the processor instantiates a parser object configured to parse the input electronic document and wherein the processor instantiates a diagram object based on the plurality of markup elements.

9. The computer system according to claim 8, wherein the diagram object includes a plurality of shape objects which represent graphic markup elements.

10. The computer system according to claim 9, wherein the diagram object includes a plurality of layers with which are associated each of the plurality of shape objects.

11. The computer system according to claim 10, wherein the processor is adapted to a display one or more of the plurality of layers.

12. The computer system according to claim 4, wherein selection of a graphics object by a user invokes a menu of selectable actions.

13. The computer system according to claim 12, wherein one or more of the selectable actions have an associated link to another input electronic document.

14. The computer system of claim 1, wherein the first object is responsive to the user input and wherein the processor generates an updated display of the first object based on the user input.

15. The computer system according to claim 14, wherein the first object is associated with a graphics element, and is responsive to a function and wherein the function provides the updated display is different than an original display of the first object.

16. The computer system according to claim 15, wherein the processor instantiates a second graphics object having a defined relation to the first graphics object and is adapted to change a representation of the second graphics object when the original display is updated.

17. An electronically published document comprising a computer readable medium with computer logic stored thereon and defining descriptive markup defining several tags, wherein each tag defines an element, wherein an element is interpreted to define a diagram containing a plurality of layers, wherein each layer contains several graphical objects, and wherein each object may have associated therewith a menu of actions or hypertext links.

18. A computer system or computer-implemented process which processes such an electronically published document as defined in claim 17 and generates on a computer display the diagram defined by the descriptive markup, wherein the different layers of the document are displayed selectively.

19. A computer-readable medium having computer-readable logic stored therein defining a data structure for representing an electronic document, the data structure comprising:
means defining the electronic document as a plurality of markup elements defining a first one of the plurality of markup elements wherein the one includes an attribute expressing relation to a second element.

20. The computer-readable medium of claim 19, wherein the one of the plurality of markup elements may be instantiated as an object by a computer process.

21. The computer-readable medium of claim 19, wherein the one of the plurality of markup elements is a graphics element.

22. The computer-readable medium of claim 19, the data structure further comprising means for defining a menu having selections associated with the one, wherein each element has an associated link.

23. The computer-readable medium of claim 19, wherein the first and second elements are graphical elements, and wherein an interpreted display of the first element depends on attributes of the second object.

24. An object-oriented computer system for generating and displaying an electronic document including a plurality of markup language elements, the system comprising:
a parser object class wherein an instance of the parser object class comprises a method adapted to parse the electronic document;
a diagram object class wherein an instance of the diagram object class is generated by the parser object class and comprises a plurality of shape objects representing graphic elements; and
a view handler object class wherein an instance of the view handler object class comprises a method for manipulating the diagram object used by the parser object class to generate an updated diagram object.

25. The object-oriented system of claim 24 wherein a first instance of the shape object class has a defined relation to a second instance of the shape object class and is adapted by a change in the second instance.

26. A method for generating and displaying an electronically-published document having a plurality of markup elements, the method comprising the steps of:
parsing an input electronic document;
generating a display of the input electronic document;
responding to a user input by generating a different display of the electronic document based on the user input.

27. The method according to claim 26, wherein the parsing step includes the steps of:
reading a markup element of the input electronic document; and
instantiating a first object associated with the markup element.

28. The method according to claim 27, wherein the responding and generating step includes the steps of:
determining a change in the first object based upon the user input;
determining a change in a second object based on the change in the first object; and
generating a display of the changed first and second objects.

29. The method according to claim 28, wherein the first and second objects are graphics objects and the change in the first object is a change in zoom.

30. The method according to claim 26, wherein the input electronic document comprises a plurality of markup elements wherein at least one of the markup elements is a graphics element, and wherein the responding step includes the steps of:
displaying the graphics element; and
generating, in response to the user input, a different display of the graphics element.

31. A method for processing an electronically-published document having a plurality of markup elements, the method comprising the steps of:
parsing an input electronic document;
reading a plurality of markup elements of the input electronic document;
instantiating objects corresponding to the plurality of markup elements; and
generating output and accepting inputs, by at least one object to a user.
